(19) United States
(12) Patent Application Publication
(10) Pub. No.: US 2026/0329127 A1
(43) Pub. Date: Oct. 22, 2026

(54) DISPLAY DEVICE

(71) Applicant: Japan Display Inc., Tokyo (JP)

(72) Inventor: Kazunari TOMIZAWA, Tokyo (JP)

(21) Appl. No.: 19/647,179

(22) Filed: Apr. 14, 2026

(30) Foreign Application Priority Data
Apr. 18, 2025 (JP) 2025-068869

(51) Int. Cl. G02F 1/1335

(52) U.S. Cl. CPC G02F 1/133514; G02F 1/133504

(57) ABSTRACT

According to an aspect, a display device includes: a light source device; a first polarizing plate on which light from the light source device is incident; a first liquid crystal display panel on which light transmitted through the first polarizing plate is incident; a second liquid crystal display panel on which light transmitted through the first liquid crystal display panel is incident; and a second polarizing plate on which light transmitted through the second liquid crystal display panel is incident. A first sub pixel having a first color filter, a second sub pixel having a second color filter, and a third sub pixel having a third color filter are arranged in one of the first and second liquid crystal display panels. The first sub pixel, the second sub pixel, the third sub pixel, and a fourth sub pixel having a fourth color filter are arranged in the other panel thereof.

### CROSS-REFERENCE TO RELATED APPLICATION

This application claims the benefit of priority from Japanese Patent Application No. 2025-068869 filed on Apr. 18, 2025, the entire contents of which are incorporated herein by reference.

### BACKGROUND

### 1. Technical Field

What is disclosed herein relates to a display device.

### 2. Description of the Related Art

In Japanese Patent Application Laid-open Publication No. 2019-008200 (JP-A-2019-008200), a wristwatch-type electronic apparatus such as a so-called smartwatch is disclosed as an example of a display device. The display device of JP-A-2019-008200 includes a first display panel and a second display panel disposed so as to overlap each other in plan view with an air layer interposed therebetween. The first display panel is capable of color display, and the second display panel is capable of monochrome display.

A color filter transmits light having a wavelength corresponding to the color of the color filter. In other words, a color filter reduces transmission of light in a color other than the color of the color filter. Accordingly, the luminance of transmitted light through a color filter is lower than the luminance of incident light. As a result, in the display device of JP-A-2019-008200, when both the first display panel and the second display panel include color filters and constitute liquid crystal display panel capable of color display, the luminance of an image visually recognized by a user may be relatively low.

For the foregoing reasons, there is a need for improving the luminance of an image visually recognized by a user in a display device in which two liquid crystal display panels are disposed so as to overlap each other in plan view.

### SUMMARY

According to an aspect, a display device includes: a light source device; a first polarizing plate on which light from the light source device is incident and that transmits linearly-polarized light having a first polarization direction; a first liquid crystal display panel on which light transmitted through the first polarizing plate is incident; a second liquid crystal display panel that is disposed apart from the first liquid crystal display panel and on which light transmitted through the first liquid crystal display panel is incident; and a second polarizing plate on which light transmitted through the second liquid crystal display panel is incident and that transmits linearly-polarized light having a second polarization direction different from the first polarization direction. No polarizing plate is disposed between the first liquid crystal display panel and the second liquid crystal display panel. A first sub pixel having a first color filter, a second sub pixel having a second color filter, and a third sub pixel having a third color filter are arranged in a matrix of rows and columns in one of the first liquid crystal display panel and the second liquid crystal display panel. The first sub pixel, the second sub pixel, the third sub pixel, and a fourth sub pixel having a fourth color filter are arranged in a matrix of rows and columns in the other of the first liquid crystal display panel and the second liquid crystal display panel.

According to an aspect, a display device includes: a light source device; a first polarizing plate on which light from the light source device is incident and that transmits linearly-polarized light having a first polarization direction; a first liquid crystal display panel on which light transmitted through the first polarizing plate is incident; a second liquid crystal display panel that is disposed apart from the first liquid crystal display panel and on which light transmitted through the first liquid crystal display panel is incident; and a second polarizing plate on which light transmitted through the second liquid crystal display panel is incident and that transmits linearly-polarized light having a second polarization direction different from the first polarization direction. No polarizing plate is disposed between the first liquid crystal display panel and the second liquid crystal display panel. A first sub pixel having a first color filter, a second sub pixel having a second color filter, and a third sub pixel having a third color filter are arranged in a matrix of rows and columns in one of the first liquid crystal display panel and the second liquid crystal display panel. A fourth sub pixel having a fourth color filter, a fifth sub pixel having a fifth color filter, and a sixth sub pixel having a sixth color filter are arranged in a matrix of rows and columns in the other of the first liquid crystal display panel and the second liquid crystal display panel.

According to an aspect, a display device includes: a light source device; a first polarizing plate on which light from the light source device is incident and that

transmits linearly-polarized light having a first polarization direction; a first liquid crystal display panel on which light transmitted through the first polarizing plate is incident; a second liquid crystal display panel that is disposed apart from the first liquid crystal display panel and on which light transmitted through the first liquid crystal display panel is incident; and a second polarizing plate on which light transmitted through the second liquid crystal display panel is incident and that transmits linearly-polarized light having a second polarization direction different from the first polarization direction. No polarizing plate is disposed between the first liquid crystal display panel and the second liquid crystal display panel. A first sub pixel having a first color filter, a second sub pixel having a second color filter, and a third sub pixel having a third color filter are arranged in a matrix of rows and columns in each of the first liquid crystal display panel and the second liquid crystal display panel. The size of the first sub pixel, the size of the second sub pixel, and the size of the third sub pixel in the first liquid crystal display panel are different from the size of the first sub pixel, the size of the second sub pixel, and the size of the third sub pixel in the second liquid crystal display panel.

### BRIEF DESCRIPTION OF THE DRAWINGS

FIG. 1 is a schematic diagram illustrating the configuration of a display device according to a first embodiment of the present disclosure;

FIG. 2 is a plan view of a liquid crystal display panel illustrated in FIG. 1;

FIG. 3 is a diagram illustrating a circuit configuration of the liquid crystal display panel illustrated in FIG. 2;

FIG. 4 is a sectional view of the liquid crystal display panel illustrated in FIG. 2;

FIG. 5 is a diagram illustrating an arrangement of sub pixels in a second liquid crystal display panel illustrated in FIG. 1;

FIG. 6 is a diagram illustrating an arrangement of sub pixels in a first liquid crystal display panel illustrated in FIG. 1;

FIG. 7 is a diagram illustrating an arrangement of sub pixels in the second liquid crystal display panel of the display device according to a third modification of the first embodiment of the present disclosure;

FIG. 8 is a diagram illustrating an arrangement of sub pixels in the first liquid crystal display panel of the display device according to a second embodiment of the present disclosure;

FIG. 9 is a diagram illustrating an arrangement of sub pixels in the first liquid crystal display panel of the display device according to a third embodiment of the present disclosure;

FIG. 10 is a diagram illustrating an arrangement of sub pixels in the first liquid crystal display panel of the display device according to a fourth embodiment of the present disclosure; and

FIG. 11 is a diagram illustrating the configuration of the display device according to another modification of the first embodiment of the present disclosure.

### DETAILED DESCRIPTION

Embodiments of the present disclosure will be described below with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

An X direction, a Y direction, and a Z direction illustrated in the drawings are orthogonal to each other and indicate directions of a display device 1. The X direction and the Y direction correspond to side directions of the display device 1. In the X direction, the side indicated by an arrow corresponds to the positive X side, and the opposite side thereto corresponds to the negative X side. In the Y direction, the side indicated by an arrow corresponds to the positive Y side, and the opposite side thereto corresponds to the negative Y side. In the Z direction, the side indicated by an arrow corresponds to the positive Z side, and the opposite side corresponds to the negative Z side. The Z direction corresponds to the thickness direction of the display device 1. The X, Y, and Z directions are exemplary, and the present disclosure is not limited to these directions. In the present disclosure, when simply referred to as "plan view", it means viewing the display device 1 along the Z direction.

### First Embodiment

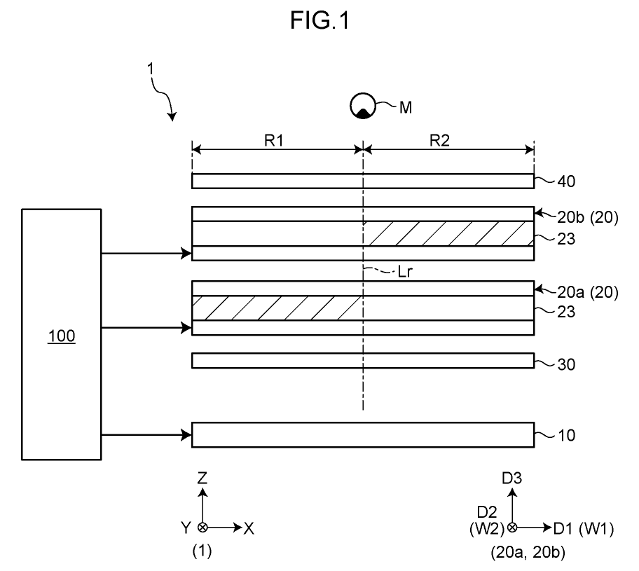

FIG. 1 is a schematic diagram illustrating the configuration of the display device 1 according to a first embodiment of the present disclosure. Examples of the display device 1 include a wristwatch-type electronic apparatus such as a smartwatch, and an instrument panel attached to a vehicle such as an automobile.

The display device 1 includes a light source device 10, a first liquid crystal display panel 20a, a second liquid crystal display panel 20b, a first polarizing plate 30, and a second polarizing plate 40. The light source device 10, the first polarizing plate 30, the first liquid crystal display panel 20a, the second liquid crystal display panel 20b, and the second polarizing plate 40 are disposed in the stated order from the negative Z side toward the positive Z side.

The light source device 10 emits light toward the first polarizing plate 30. The light source device 10 is, for example, a direct-type backlight and includes a plurality of light-emitting diodes (not illustrated). The light source device 10 is electrically coupled to an external device 100 in a wired or wireless manner, and a light emission timing, a light emission time, and the like thereof are controlled.

The first liquid crystal display panel 20a and the second liquid crystal display panel 20b are transmissive liquid crystal displays. In the first embodiment, the first liquid crystal display panel 20a and the second liquid crystal display panel 20b are similarly configured except for kinds of sub pixels S to be described later. Hereinafter, the first liquid crystal display panel 20a and the second liquid crystal display panel 20b are simply referred to as a liquid crystal display panel 20 when they are described without distinction between them.

A first panel direction D1, a second panel direction D2, and a third panel direction D3 illustrated in the drawings are orthogonal to each other and indicate directions of the liquid crystal display panel 20. The first panel direction D1 and the second panel direction D2 correspond to directions parallel to a principal surface of a substrate included in the liquid crystal display panel 20. The third panel direction D3 corresponds to a direction orthogonal to the principal surface of a substrate included in the liquid crystal display panel 20. The third panel direction D3 corresponds to the thickness direction of the liquid crystal display panel 20. In the third panel direction D3, the side indicated by an arrow (positive D3 side) corresponds to a front surface side of the liquid crystal display panel 20 on which an image is displayed, and the opposite side (negative D3 side) corresponds to a back surface side of the liquid crystal display panel 20. The first panel direction D1, the second panel direction D2, and the third panel direction D3 are exemplary, and the present disclosure is not limited to these directions.

The liquid crystal display panel 20 is disposed such that the third panel direction D3 and the Z direction are parallel. The liquid crystal display panel 20 is electrically coupled to the external device 100 in a wired or wireless manner, and displays an image based on an image signal transmitted from the external device 100. The first liquid crystal display panel 20a and the second liquid crystal display panel 20b are disposed so as to be spaced apart from each other in the Z direction and overlap each other in plan view.

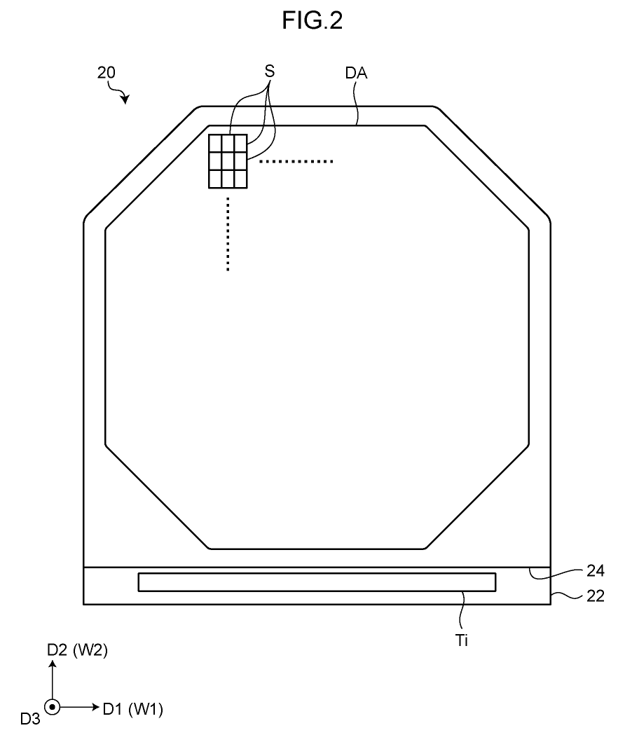

FIG. 2 is a plan view of the liquid crystal display panel 20 illustrated in FIG. 1. The front surface of the liquid crystal display panel 20 has a display region DA in which an image is displayed. The front surface of the liquid crystal display panel 20 is orthogonal to the Z direction. The display region DA has a polygonal shape in plan view, but may have a quadrilateral shape. The display region DA of the first liquid crystal display panel 20a and the display region DA of the second liquid crystal display panel 20b overlap each other in plan view.

In the display region DA, a plurality of sub pixels S are arranged in a matrix of rows in a row direction W1 and columns in a column direction W2. The row direction W1 and the column direction W2 are orthogonal to each other. The row direction W1 is parallel to the first panel direction D1, and the column direction W2 is parallel to the second panel direction D2. The sub pixels S each have a rectangular shape having a long side direction and a short side direction in plan view. The sub pixels S are disposed such that the long side direction is parallel to the column direction W2 and the short side direction is parallel to the row direction W1. Details of the sub pixels S will be described later.

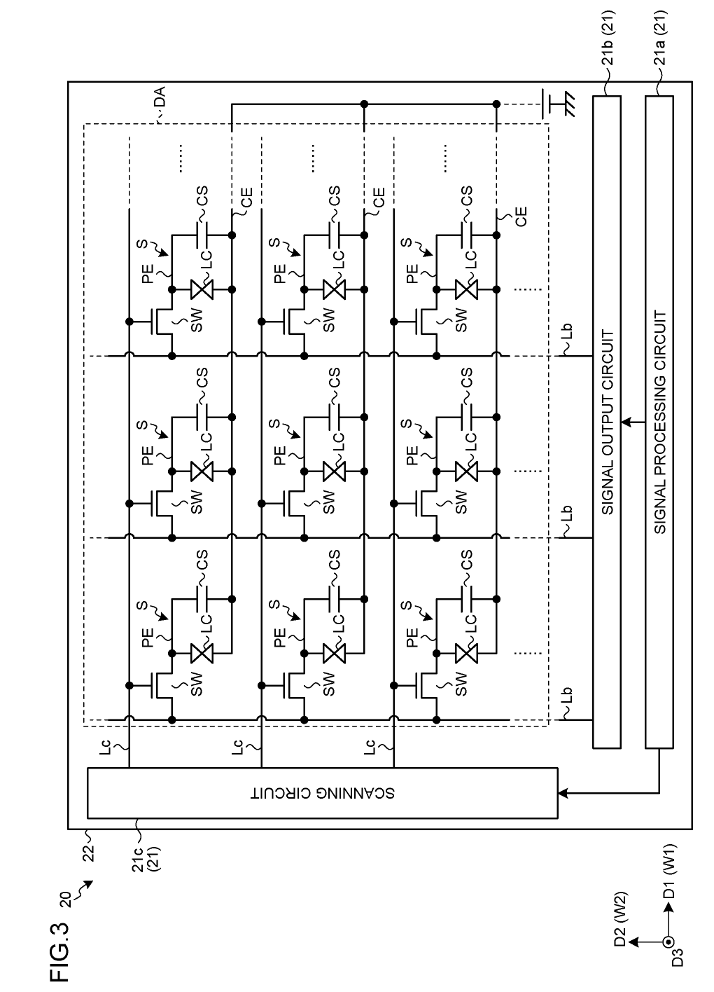

FIG. 3 is a diagram illustrating a circuit configuration of the liquid crystal display panel 20 illustrated in FIG. 2. The liquid crystal display panel 20 includes a drive circuit 21, and a switching element SW, a sub pixel electrode PE, a common electrode CE, a liquid crystal capacitance LC, and a storage capacitor CS provided in each of the sub pixels S.

The drive circuit 21 displays an image in the display region DA. The drive circuit 21 includes a signal processing circuit 21a, a signal output circuit 21b, and a scanning circuit 21c.

The signal processing circuit 21a generates sub pixel signals, which will be described later, based on an image signal output from the external device 100, and outputs the generated sub pixel signals to the signal output circuit 21b. The signal processing circuit 21a also outputs a clock signal synchronizing operation of the signal output circuit 21b and operation of the scanning circuit 21c to the signal output circuit 21b and the scanning circuit 21c.

The signal output circuit 21b outputs the sub pixel signals to the corresponding sub pixels S. The signal output circuit 21b is electrically coupled to the sub pixels S through a plurality of signal lines Lb extending in the column direction W2.

The scanning circuit 21c scans the sub pixels S in synchronization with the outputting of the sub pixel signals from the signal output circuit 21b. The scanning circuit 21c is electrically coupled to the sub pixels S through a plurality of scanning lines Lc extending in the row direction W1.

In plan view, each region partitioned by two signal lines Lb adjacent to each other in the row direction W1 and two scanning lines Lc adjacent to each other in the column direction W2 corresponds to one of the sub pixels S.

The switching element SW includes, for example, a thin film transistor (TFT). The switching element SW has a source electrode electrically coupled to the signal lines Lb, and a gate electrode electrically coupled to the scanning lines Lc.

The sub pixel electrode PE is coupled to a drain electrode of the switching element SW. The common electrodes CE are disposed corresponding to the sub pixel electrodes PE. The sub pixel electrode PE and the common electrode CE have a light-transmitting property.

The liquid crystal capacitance LC is a capacitive component of a liquid crystal material of a liquid crystal layer 23 to be described later between the sub pixel electrode PE and the common electrode CE. The storage capacitor CS is formed between an electrode at the same potential as the common electrode CE and an electrode at the same potential as the sub pixel electrode PE.

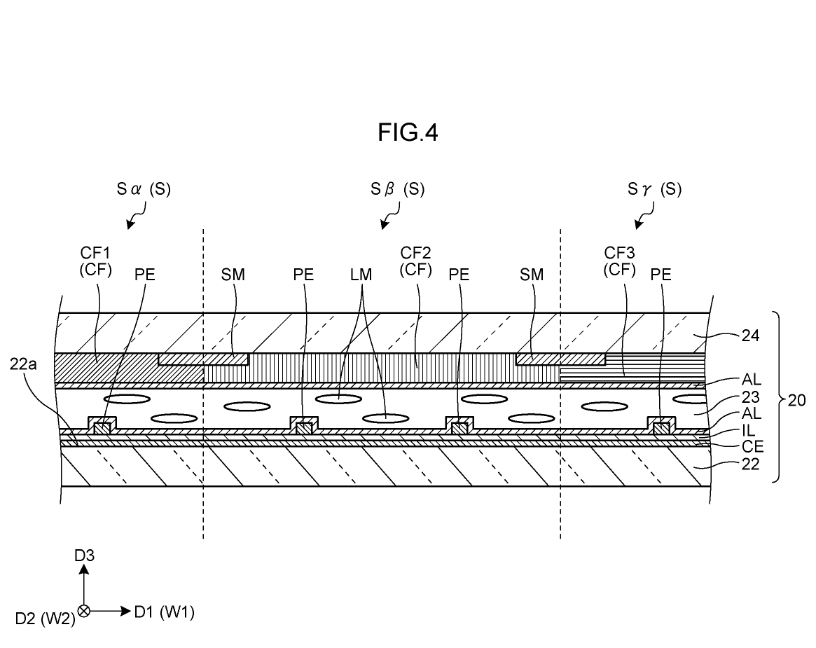

FIG. 4 is a sectional view of the liquid crystal display panel 20 illustrated in FIG. 2. The liquid crystal display panel 20 includes a first substrate 22, the liquid crystal layer 23, and a second substrate 24.

The first substrate 22, the liquid crystal layer 23, and the second substrate 24 have a light-transmitting property and are disposed in the stated order from the negative D3 side toward the positive D3 side. An IC chip Ti, which constitutes the drive circuit 21, is disposed on the first substrate 22 (FIG. 2).

The common electrode CE is disposed on a principal surface 22a corresponding to a front surface of the first substrate 22. An insulating layer IL is disposed on a front surface of the common electrode CE, and the sub pixel electrode PE and an alignment film AL are disposed thereon.

The sub pixel electrode PE is disposed between the insulating layer IL and the alignment film AL. In this manner, the common electrode CE and the sub pixel electrode PE are disposed on the first substrate 22. That is, the liquid crystal display panel 20 is a liquid crystal display of a horizontal electric field type. The signal lines Lb and the scanning lines Lc (not illustrated in FIG. 4) are disposed on the principal surface 22a of the first substrate 22.

The second substrate 24 is positioned on the positive D3 side of the first substrate 22. Color filters CF, a light-shielding film SM, and an alignment film AL are disposed on a back surface of the second substrate 24. The light-shielding films SM and the color filters CF are disposed between the second substrate 24 and the alignment films AL.

Each color filter CF transmits light having a wavelength corresponding to the color of the color filter CF. The second liquid crystal display panel 20b includes three color filters CF of a first color filter CF1, a second color filter CF2, and a third color filter CF3. The color of the first color filter CF1 is red, the color of the second color filter CF2 is green, and the color of the third color filter CF3 is blue. Hereinafter, the first color filter CF1, the second color filter CF2, and the third color filter CF3 are simply referred to as color filters CF when they are described without distinction between them.

Each sub pixel S has one color filter CF. A sub pixel S having a first color filter CF1 is referred to as a first sub pixel Sα, a sub pixel S having a second color filter CF2 is referred to as a second sub pixel Sβ, and a sub pixel S having a third color filter CF3 is referred to as a third sub pixel Sγ. That is, the first sub pixel Sα is a red sub pixel S, the second sub pixel Sβ is a green sub pixel S, and the third sub pixel Sγ is a blue sub pixel S. The first sub pixel Sα, the second sub pixel Sβ, and the third sub pixel Sγ are simply referred to as the sub pixels S when they are described without distinction between them.

The light-shielding films SM has a light-blocking property. The light-shielding film SM overlaps the signal lines Lb and the scanning lines Lc in the third panel direction D3. That is, the light-shielding film SM partitions the sub pixels S. In other words, in the third panel direction D3, the light-shielding film SM overlaps the boundary of two sub pixels S adjacent to each other in the row direction W1 and the column direction W2.

The liquid crystal layer 23 contains a plurality of liquid crystal molecules LM. The liquid crystal layer 23 is disposed between the two alignment films AL facing each other in the third panel direction D3. Alignment of the liquid crystal molecules LM is regulated by the two alignment films AL.

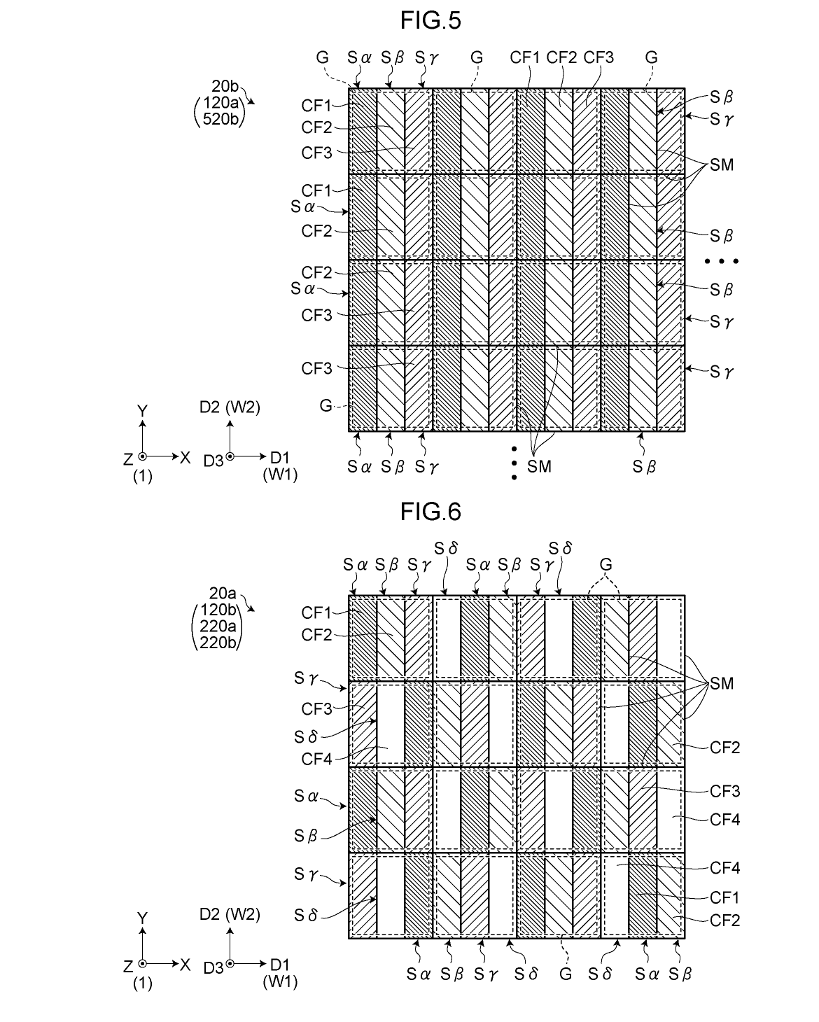

FIG. 5 is a diagram illustrating an arrangement of the sub pixels S of the second liquid crystal display panel 20b illustrated in FIG. 1. The sub pixels S illustrated in the diagram are indicated by the color filters CF and the light-shielding film SM. In a plan view of the liquid crystal display panel 20, the sub pixels S are partitioned by the light-shielding film SM, and the color filters CF have quadrilateral shapes.

The arrangement of the sub pixels S in the second liquid crystal display panel 20b is a so-called stripe arrangement. Specifically, in the second liquid crystal display panel 20b, the first sub pixel Sα, the second sub pixel Sβ, and the third sub pixel Sγ are repeatedly arranged in the stated order in the row direction W1, and the first sub pixels Sα are consecutively arranged in the column direction W2, the second sub pixels Sβ are consecutively arranged in the column direction W2, and the third sub pixels Sγ are consecutively arranged in the column direction W2.

Each of a plurality of pixels G constituting an image is composed of one first sub pixel Sα, one second sub pixel Sβ, and one third sub pixel Sγ that are consecutively arranged in the row direction W1. Each pixel G has a square shape in a plan view of the liquid crystal display panel 20. The pixels G are arranged in a matrix of rows and columns along the row direction W1 and the column direction W2.

The second liquid crystal display panel 20b is disposed in the display device 1 such that the row direction W1 (first panel direction D1) aligns with the X direction and the column direction W2 (second panel direction D2) aligns with the Y direction (refer to FIGS. 1 and 5).

FIG. 6 is a diagram illustrating an arrangement of the sub pixels S in the first liquid crystal display panel 20a illustrated in FIG. 1. Each sub pixel S of the first liquid crystal display panel 20a and each sub pixel S of the second liquid crystal display panel 20b have the same shape and the same size in plan view.

The first liquid crystal display panel 20a includes four color filters CF of the first color filter CF1, the second color filter CF2, the third color filter CF3, and a fourth color filter CF4. The color of the fourth color filter CF4 is white. A sub pixel S having the fourth color filter CF4 is referred to as a fourth sub pixel Sδ. The fourth sub pixel Sδ is a white sub pixel S. The fourth color filter CF4 may be colorless and transparent.

In the first liquid crystal display panel 20a, the first sub pixel Sα, the second sub pixel Sβ, the third sub pixel Sγ, and the fourth sub pixel Sδ are repeatedly arranged in the stated order in the row direction W1, the first sub pixel Sα and the third sub pixel Sγ are alternately arranged in the column direction W2, and the second sub pixel Sβ and the fourth sub pixel Sδ are alternately arranged in the column direction W2.

Similarly to the second liquid crystal display panel 20b, the first liquid crystal display panel 20a is disposed in the display device 1 such that the row direction W1 (first panel direction D1) aligns with the X direction and the column direction W2 (second panel direction D2) aligns with the Y direction (refer to FIGS. 1 and 6).

Light from the light source device 10 is incident on the first polarizing plate 30 illustrated in FIG. 1. The first polarizing plate 30 transmits linearly-polarized light polarized along a first polarization direction. The first polarization direction is orthogonal to the Z direction. The light transmitted through the first polarizing plate 30 is linearly-polarized light along the first polarization direction. The light transmitted through the first polarizing plate 30 is incident on the first liquid crystal display panel 20a.

The light transmitted through the second liquid crystal display panel 20b is incident on the second polarizing plate 40. The second polarizing plate 40 transmits linearly-polarized light in a second polarization direction different from the first polarization direction. The second polarization direction is orthogonal to the Z direction and the first polarization direction. The light transmitted through the second polarizing plate 40 is linearly-polarized light in the second polarization direction. The light transmitted through the second polarizing plate 40 is visually recognized by a user M of the display device 1.

No polarizing plate is disposed between the first liquid crystal display panel 20a and the second liquid crystal display panel 20b. With the display device 1 configured in this manner, the user M can visually recognize an image displayed on the first liquid crystal display panel 20a when no voltage is applied to the second liquid crystal display panel 20b, and can visually recognize an image displayed on the second liquid crystal display panel 20b when no voltage is applied to the first liquid crystal display panel 20a (to be described later in detail).

The following describes operation of the display device 1. The description will be first made on a case where the display mode of the liquid crystal display panel 20 is a so-called normally black mode, no image signal is transmitted from the external device 100 to the display device 1, and the display device 1 displays black. In this case, in both the first liquid crystal display panel 20a and the second liquid crystal display panel 20b, the drive circuit 21 applies no voltage to the sub pixels S, and no electric field is generated in the liquid crystal layer 23. Accordingly, the alignment of the liquid crystal molecules LM is regulated to the initial alignment (horizontal alignment; direction orthogonal to the Z direction) by the alignment films AL.

Light from the light source device 10 is incident on the first polarizing plate 30. The light transmitted through the first polarizing plate 30 is incident on the liquid crystal layer 23 of the first liquid crystal display panel 20a.

When the alignment of the liquid crystal molecules LM is regulated to the initial alignment by the alignment films AL, the polarization axis of light passing through the liquid crystal layer 23 is not rotated. Light transmitted through the liquid crystal layer 23 of the first liquid crystal display panel 20a is transmitted through the first liquid crystal display panel 20a while maintaining the first polarization direction, and is incident on the second liquid crystal display panel 20b.

Also in the liquid crystal layer 23 of the second liquid crystal display panel 20b, similarly to the liquid crystal layer 23 of the first liquid crystal display panel 20a, the polarization axis of light passing through the liquid crystal layer 23 does not rotate. Light transmitted through the liquid crystal layer 23 of the second liquid crystal display panel 20b is transmitted through the second liquid crystal display panel 20b while maintaining the first polarization direction, and is incident on the second polarizing plate 40.

The first polarization direction of the light passing through the second liquid crystal display panel 20b is orthogonal to the second polarization direction of the second polarizing plate 40. Accordingly, the light transmitted through the second liquid crystal display panel 20b does not pass through the second polarizing plate 40. As a result, the user M visually recognizes black.

The following describes operation in which the liquid crystal display panel 20 displays an image in the display region DA. The drive circuit 21 generates sub pixel signals based on an image signal transmitted from the external device 100, and outputs the sub pixel signals to the sub pixels S through the signal output circuit 21b. The sub pixel signals include sub gradation data indicating the gradation levels of the sub pixels S.

In addition, as the sub pixels S are scanned by the scanning circuit 21c, the switching elements SW are operated, and the sub pixel signals are transmitted to the sub pixel electrodes PE. Accordingly, potential difference occurs between the common electrodes CE and the sub pixel electrodes PE and the electric field is generated in the liquid crystal layer 23. As a result, the alignment of the liquid crystal molecules LM changes. The alignment of the liquid crystal molecules LM depends on the sub gradation data. Accordingly, light passing through the liquid crystal layer 23 is modulated for each sub pixel S. Light transmitted through the color filters CF has the colors of the color filters CF. In this manner, the luminance and color of light passing through the liquid crystal display panel 20 are adjusted for each sub pixel S, and accordingly, an image is displayed in the display region DA.

The following describes a case where the user M visually recognizes a first image displayed on the first liquid crystal display panel 20a and visually recognizes a second image displayed on the second liquid crystal display panel 20b.

For simplification of description, the description will be made on a case where the first image is visually recognized in a first region R1 on the negative X side of a boundary line Lr in the display device 1 illustrated in FIG. 1, and the second image is visually recognized in a second region R2 on the positive X side of the boundary line Lr.

An image signal including information of the first image is transmitted to the first liquid crystal display panel 20a. In the first liquid crystal display panel 20a, in accordance with sub pixel signals generated based on the image signal, voltage is applied to the sub pixels S corresponding to the first region R1, and no voltage is applied to the sub pixels S corresponding to the second region R2. The hatched part of each liquid crystal layer 23 in FIG. 1 indicates that voltage is applied to the sub pixels S, and the non-hatched part of each liquid crystal layer 23 indicates that no voltage is applied to the sub pixels S.

An image signal including information of the second image is transmitted to the second liquid crystal display panel 20b. In the second liquid crystal display panel 20b, in accordance with sub pixel signals generated based on the image signal, no voltage is applied to the sub pixels S corresponding to the first region R1, and voltage is applied to the sub pixels S corresponding to the second region R2.

In the first region R1, the light passing through the first liquid crystal display panel 20a is modulated, and accordingly, the first image is displayed in the display region DA of the first liquid crystal display panel 20a. The light transmitted through the first liquid crystal display panel 20a is incident on the second liquid crystal display panel 20b. No voltage is applied to the sub pixels S of the second liquid crystal display panel 20b, and the light passing through the second liquid crystal display panel 20b is not modulated. As a result, the light transmitted through the second polarizing plate 40 in the first region R1 is visually recognized as the first image by the user M.

In the second region R2, no voltage is applied to the sub pixels S of the first liquid crystal display panel 20a, and the light passing through the first liquid crystal display panel 20a is not modulated. The light transmitted through the first liquid crystal display panel 20a is incident on the second liquid crystal display panel 20b. In the second region R2, the light passing through the second liquid crystal display panel 20b is modulated, and accordingly, the second image is displayed in the display region DA of the second liquid crystal display panel 20b. As a result, the light transmitted through the second polarizing plate 40 in the second region R2 is visually recognized as the second image by the user M. The first region R1 and the second region R2 are not limited to the example illustrated in FIG. 1, but are changed depending on the shapes, sizes, and areas of the first image and the second image.

The following describes the luminance of an image visually recognized by the user M.

As described above, each color filter CF transmits light having a wavelength corresponding to the color of the color filter CF. Accordingly, the luminance of light transmitted through the color filter CF is lower than the luminance of light incident on the color filter CF. Here, transmittance is defined as the ratio of light transmitted through the liquid crystal display panel 20 to incident light in a state in which no voltage is applied to the sub pixels S of the liquid crystal display panel 20. In this case, the transmittance of the second liquid crystal display panel 20b with the first sub pixels Sα (first color filters CF1: red), the second sub pixels Sβ (second color filters CF2: green), and the third sub pixels Sγ (third color filters CF3: blue) is approximately 30%.

As described above, the color of the fourth color filter CF4 included in the fourth sub pixel Sδ of the first liquid crystal display panel 20a is white. Accordingly, the fourth color filter CF4 transmits red light, green light, and blue light. As a result, the luminance of light transmitted through the fourth sub pixel Sδ (white) is substantially equal to combined luminance of light transmitted through three sub pixels S of the first sub pixel Sα (red), the second sub pixel Sβ (green), and the third sub pixel Sγ (blue). Thus, when the sum of the luminance of light transmitted through the first sub pixel Sα (red), light transmitted through the second sub pixel Sβ (green), and light transmitted through the third sub pixel Sγ (blue) is defined as 3, the luminance of light transmitted through the fourth sub pixel Sδ (white) is 3.

In the second liquid crystal display panel 20b, one pixel G includes one first sub pixel Sα (red), one second sub pixel Sβ (green), and one third sub pixel Sγ (blue). When the unit area of the display region DA is defined as the area of one pixel G, the luminance of transmitted light per unit area of the display region DA in the second liquid crystal display panel 20b is 3.

In the first liquid crystal display panel 20a, one pixel G includes, on average, 3/4 of one first sub pixel Sα (red), 3/4 of one second sub pixel Sβ (green), 3/4 of one third sub pixel Sγ (blue), and 3/4 of one fourth sub pixel Sδ (white). Accordingly, in the first liquid crystal display panel 20a, the sum of the luminance of light transmitted through the red first sub pixel Sα, light transmitted through the green second sub pixel Sβ, and light transmitted through the blue third sub pixel Sγ per unit area of the display region DA is 9/4 (= 3×3/4), and the luminance of the light transmitted through the white fourth sub pixel Sδ per unit area of the display region DA is 9/4 (= 3×3/4). Therefore, in the first liquid crystal display panel 20a, the luminance of transmitted light per unit area of the display region DA is 4.5 (= (9/4) + (9/4)).

As a result, the transmittance of the first liquid crystal display panel 20a is 1.5 (= 4.5/3) times the transmittance of the second liquid crystal display panel 20b, and is approximately 45% (= 1.5×30%). In this manner, since the first liquid crystal display panel 20a includes the fourth sub pixel Sδ, the transmittance of the first liquid crystal display panel 20a is higher than the transmittance of the second liquid crystal display panel 20b.

Accordingly, when the display device 1 includes the first liquid crystal display panel 20a including the fourth sub pixel Sδ, the luminance of light incident on the second liquid crystal display panel 20b in the second region R2 illustrated in FIG. 1 is higher than when the first liquid crystal display panel 20a does not include the fourth sub pixel Sδ (for example, when the second liquid crystal display panel 20b is disposed in place of the first liquid crystal display panel 20a in the display device 1). Thus, the display device 1 can improve the luminance of the second image visually recognized by the user M in the second region R2. In other words, the display device 1 can improve the luminance of an image visually recognized by the user M.

### First Modification of First Embodiment

The following describes the display device 1 according to a first modification of the first embodiment of the present disclosure with a focus on differences from the display device 1 according to the first embodiment.

A first liquid crystal display panel 120a included in the display device 1 according to the first modification does not include the fourth sub pixel Sδ. The arrangement of the sub pixels S in the first liquid crystal display panel 120a is the same stripe arrangement as the arrangement of the sub pixels S in the second liquid crystal display panel 20b according to the first embodiment (FIG. 5). Specifically, in the first liquid crystal display panel 120a, the first sub pixel Sα, the second sub pixel Sβ, and the third sub pixel Sγ are repeatedly arranged in the stated order in the row direction W1, the first sub pixels Sα are consecutively arranged in the column direction W2, the second sub pixels Sβ are consecutively arranged in the column direction W2, and the third sub pixels Sγ are consecutively arranged in the column direction W2. Accordingly, the transmittance of the first liquid crystal display panel 120a is approximately 30%.

A second liquid crystal display panel 120b included in the display device 1 according to the first modification includes the fourth sub pixel Sδ. The arrangement of the sub pixels S in the second liquid crystal display panel 120b is the same as the arrangement of the sub pixels S in the first liquid crystal display panel 20a according to the first embodiment (FIG. 6). Specifically, in the second liquid crystal display panel 120b, the first sub pixel Sα, the second sub pixel Sβ, the third sub pixel Sγ, and the fourth sub pixel Sδ are repeatedly arranged in the stated order in the row direction W1, the first sub pixel Sα and the third sub pixel Sγ are alternately arranged in the column direction W2, and the second sub pixel Sβ and the fourth sub pixel Sδ are alternately arranged in the column direction W2. Accordingly, the transmittance of the second liquid crystal display panel 120b is approximately 45%.

When the display device 1 includes the second liquid crystal display panel 120b including the fourth sub pixel Sδ, the luminance of the light transmitted through the second liquid crystal display panel 120b in the first region R1 illustrated in FIG. 1 is higher than when the second liquid crystal display panel 120b does not include the fourth sub pixel Sδ (for example, when the second liquid crystal display panel 20b according to the first embodiment is disposed in place of the second liquid crystal display panel 120b in the display device 1). Thus, the display device 1 can improve the luminance of the first image visually recognized by the user M in the first region R1. In other words, the display device 1 can improve the luminance of an image visually recognized by the user M.

### Second Modification of First Embodiment

The following describes the display device 1 according to a second modification of the first embodiment of the present disclosure with a focus on differences from the display device 1 according to the first embodiment.

Each of a first liquid crystal display panel 220a and a second liquid crystal display panel 220b included in the display device 1 according to the second modification includes the fourth sub pixel Sδ. The arrangement of the sub pixels S in each of the first liquid crystal display panel 220a and the second liquid crystal display panel 220b is the same as an arrangement of the sub pixels S in the first liquid crystal display panel 20a according to the first embodiment (FIG. 6). Specifically, in each of the first liquid crystal display panel 220a and the second liquid crystal display panel 220b, the first sub pixel Sα, the second sub pixel Sβ, the third sub pixel Sγ, and the fourth sub pixel Sδ are repeatedly arranged in the stated order in the row direction W1, the first sub pixel Sα and the third sub pixel Sγ are alternately arranged in the column direction W2, and the second sub pixel Sβ and the fourth sub pixel Sδ are alternately arranged in the column direction W2. Accordingly, the transmittance of each of the first liquid crystal display panel 220a and the second liquid crystal display panel 220b is approximately 45%.

When the display device 1 includes the second liquid crystal display panel 220b including the fourth sub pixel Sδ, the luminance of the light transmitted through the second liquid crystal display panel 220b in the first region R1 illustrated in FIG. 1 is higher than when the second liquid crystal display panel 220b does not include the fourth sub pixel Sδ (for example, when the second liquid crystal display panel 20b according to the first embodiment is disposed in place of the second liquid crystal display panel 220b). Thus, the display device 1 according to the second modification can improve the luminance of the first image visually recognized by the user M in the first region R1 as compared to the display device 1 according to the first embodiment. In other words, the display device 1 can improve the luminance of an image visually recognized by the user M.

### Third Modification of First Embodiment

The following describes the display device 1 according to a third modification of the first embodiment of the present disclosure with a focus on differences from the display device 1 according to the second modification of the first embodiment. Similarly to the display device 1 according to the second modification of the first embodiment, the display device 1 according to the third modification includes the first liquid crystal display panel 220a (FIG. 6).

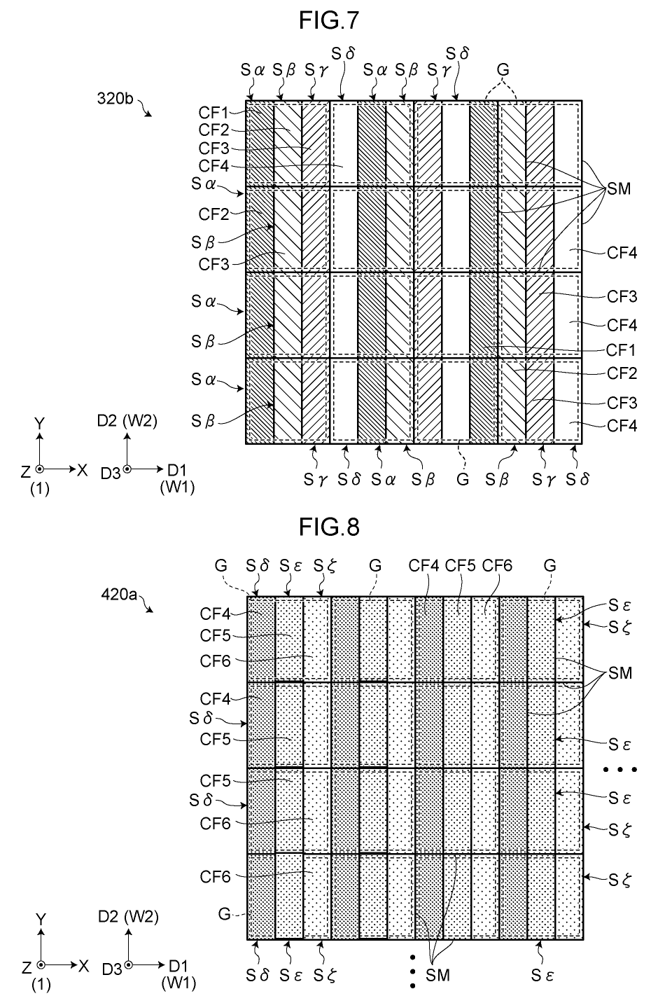

FIG. 7 is a diagram illustrating an arrangement of the sub pixels S in a second liquid crystal display panel 320b of the display device 1 according to the third modification of the first embodiment of the present disclosure.

In the third modification, the arrangement of the sub pixels S in the second liquid crystal display panel 320b is a stripe arrangement. Specifically, in the second liquid crystal display panel 320b, the first sub pixel Sα, the second sub pixel Sβ, the third sub pixel Sγ, and the fourth sub pixel Sδ are repeatedly arranged in the stated order in the row direction W1, the first sub pixels Sα are consecutively arranged in the column direction W2, the second sub pixels Sβ are consecutively arranged in the column direction W2, the third sub pixels Sγ are consecutively arranged in the column direction W2, and the fourth sub pixels Sδ are consecutively arranged in the column direction W2.

The numbers of the red first sub pixels Sα, the green second sub pixels Sβ, the blue third sub pixels Sγ, and the white fourth sub pixels Sδ included in one pixel G are equal between the second liquid crystal display panel 320b according to the third modification and the first liquid crystal display panel 20a according to the first embodiment. Thus, the transmittance of the second liquid crystal display panel 320b is 45%.

Thus, similarly to the display device 1 according to the second modification of the first embodiment, the display device 1 according to the third modification can improve the luminance of an image visually recognized by the user M.

In the display device 1 according to the third modification, the arrangement of the sub pixels S in the first liquid crystal display panel 220a may be the same stripe arrangement as the arrangement of the sub pixels S in the second liquid crystal display panel 320b. In this case, the arrangement of the sub pixels S in the second liquid crystal display panel 320b may be the same as arrangement of the sub pixels S in the second liquid crystal display panel 220b (FIG. 6).

### Second Embodiment

The following describes the display device 1 according to a second embodiment of the present disclosure with a focus on differences from the display device 1 according to the first embodiment. Similarly to the display device 1 according to the first embodiment, the display device 1 according to the second embodiment includes the second liquid crystal display panel 20b (FIG. 5).

FIG. 8 is a diagram illustrating an arrangement of the sub pixels S in a first liquid crystal display panel 420a of the display device 1 according to the second embodiment of the present disclosure.

The first liquid crystal display panel 420a according to the second embodiment does not include the first color filter CF1, the second color filter CF2, and the third color filter CF3, but includes three color filters CF of a fourth color filter CF4, a fifth color filter CF5, and a sixth color filter CF6.

In the second embodiment, the color of the fourth color filter CF4 is cyan, the color of the fifth color filter CF5 is magenta, and the color of the sixth color filter CF6 is yellow.

A sub pixel S having the fourth color filter CF4 is referred to as a fourth sub pixel Sδ, a sub pixel S having the fifth color filter CF5 is referred to as a fifth sub pixel Sε, and a sub pixel S having the sixth color filter CF6 is referred to as a sixth sub pixel Sζ. Specifically, the fourth sub pixel Sδ is a cyan sub pixel S, the fifth sub pixel Sε is a magenta sub pixel S, and the sixth sub pixel Sζ is a yellow sub pixel S.

The arrangement of the sub pixels S in the first liquid crystal display panel 420a is a stripe arrangement. Specifically, in the first liquid crystal display panel 420a, the fourth sub pixel Sδ, the fifth sub pixel Sε, and the sixth sub pixel Sζ are repeatedly arranged in the stated order in the row direction W1, the fourth sub pixels Sδ are consecutively arranged in the column direction W2, the fifth sub pixels Sε are consecutively arranged in the column direction W2, and the sixth sub pixels Sζ are consecutively arranged in the column direction W2.

The following describes the transmittance of the first liquid crystal display panel 420a.

The fourth color filter CF4 (cyan) transmits green light and blue light. The fifth color filter CF5 (magenta) transmits blue light and red light. The sixth color filter CF6 (yellow) transmits red light and green light. Specifically, when the sum of the luminance of the light transmitted through the first sub pixel Sα (red), light transmitted through the second sub pixel Sβ (green), and light transmitted through the third sub pixel Sγ (blue) is 3, the sum of the luminance of the light transmitted through the fourth sub pixels Sδ (cyan), light transmitted through the fifth sub pixel Sε (magenta), and light transmitted through the sixth sub pixel Sζ (yellow) is 6.

In the first liquid crystal display panel 420a, one pixel G includes one fourth sub pixel Sδ (cyan), one fifth sub pixel Sε (magenta), and one sixth sub pixel Sζ (yellow). Accordingly, in the first liquid crystal display panel 420a, the luminance of transmitted light per unit area of the display region DA is 6.

As described above, in the second liquid crystal display panel 20b, one pixel G includes one red first sub pixel Sα, one green second sub pixel Sβ, and one blue third sub pixel Sγ, and the luminance of transmitted light per unit area of the display region DA is 3.

As a result, the transmittance of the first liquid crystal display panel 420a is 2 (= 6/3) times the transmittance of the second liquid crystal display panel 20b, and is approximately 60% (= 2×30%). In this manner, since each sub pixel S of the first liquid crystal display panel 420a includes the fourth sub pixel Sδ, the fifth sub pixel Sε, and the sixth sub pixel Sζ, the transmittance of the first liquid crystal display panel 420a is higher than the transmittance of the second liquid crystal display panel 20b.

Accordingly, similarly to the display device 1 according to the first embodiment, the display device 1 according to the second embodiment can improve the luminance of the second image visually recognized by the user M in the second region R2. In other words, the display device 1 can improve the luminance of an image visually recognized by the user M.

### Modification of Second Embodiment

The following describes the display device 1 according to a modification of the second embodiment of the present disclosure with a focus on differences from the display device 1 according to the second embodiment. Similarly to the display device 1 according to the second embodiment, the display device 1 according to the modification of the second embodiment includes the first liquid crystal display panel 420a (FIG. 8).

In a second liquid crystal display panel 520b of the display device 1 according to the present modification, the color of the first color filters CF1 is cyan, the color of the second color filters CF2 is magenta, and the color of the third color filters CF3 is yellow. The arrangement of the sub pixels S in the second liquid crystal display panel 520b is the same stripe arrangement as the second liquid crystal display panel 20b according to the first embodiment described above (FIG. 5). Accordingly, the transmittance of the second liquid crystal display panel 520b according to the present modification is 60%.

Thus, the display device 1 according to the present modification can improve the luminance of the first image visually recognized by the user M in the first region R1 as compared to the display device 1 according to the second embodiment. In other words, the display device 1 can improve the luminance of an image visually recognized by the user M.

In the first liquid crystal display panel 420a of the display device 1 according to the present modification, the color of the fourth color filter CF4 may be red, the color of the fifth color filter CF5 may be green, and the color of the sixth color filter CF6 may be blue.

### Third Embodiment

The following describes the display device 1 according to a third embodiment of the present disclosure with a focus on differences from the display device 1 according to the first embodiment. Similarly to the display device 1 according to the first embodiment, the display device 1 according to the third embodiment includes the second liquid crystal display panel 20b (FIG. 5).

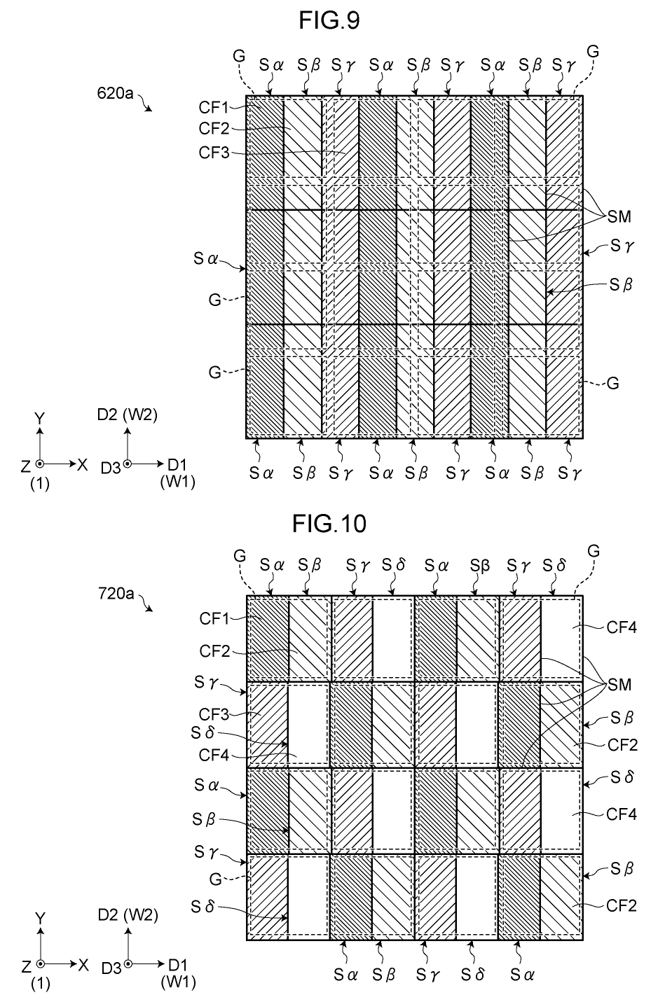

FIG. 9 is a diagram illustrating an arrangement of the sub pixels S in a first liquid crystal display panel 620a of the display device 1 according to the third embodiment of the present disclosure.

In the third embodiment, the first liquid crystal display panel 620a does not include the fourth sub pixel Sδ. The arrangement of the sub pixels S in the first liquid crystal display panel 620a is the same stripe arrangement as the arrangement of the sub pixels S in the second liquid crystal display panel 20b according to the first embodiment. Specifically, in the first liquid crystal display panel 620a, the first sub pixel Sα, the second sub pixel Sβ, and the third sub pixel Sγ are repeatedly arranged in the stated order in the row direction W1, the first sub pixels Sα are consecutively arranged in the column direction W2, the second sub pixels Sβ are consecutively arranged in the column direction W2, and the third sub pixels Sγ are consecutively arranged in the column direction W2.

The size of each sub pixel S in the first liquid crystal display panel 620a is different from the size of each sub pixel S in the second liquid crystal display panel 20b. The size of the sub pixel S in the first liquid crystal display panel 620a is larger than the size of the sub pixel S in the second liquid crystal display panel 20b. Specifically, as for each of the length of the sub pixel S in the long side direction (column direction W2) and the length of the sub pixel S in the short side direction (row direction W1), the sub pixel S in the first liquid crystal display panel 620a is 4/3 times the sub pixel S in the second liquid crystal display panel 20b.

Accordingly, in the first liquid crystal display panel 620a, the ratio of the area of the light-shielding films SM included in one pixel G to the entire area of the one pixel G, in other words, the ratio of the area of the light-shielding films SM per unit area of the display region DA, is smaller than that in the second liquid crystal display panel 20b. As a result, the transmittance of the first liquid crystal display panel 620a is larger than the transmittance of the second liquid crystal display panel 20b and is approximately 36%.

When the size of each sub pixel S in the first liquid crystal display panel 620a is larger than that in the second liquid crystal display panel 20b, the luminance of light incident on the second liquid crystal display panel 20b in the second region R2 illustrated in FIG. 1 is higher than when the size of each sub pixel S in the first liquid crystal display panel 620a is equal to the size of each sub pixel S in the second liquid crystal display panel 20b. "When the size of each sub pixel S in the first liquid crystal display panel 620a is equal to the size of each sub pixel S in the second liquid crystal display panel 20b" refers, for example, to a case in which the second liquid crystal display panel 20b according to the first embodiment is disposed in place of the first liquid crystal display panel 620a. Thus, the display device 1 can improve the luminance of the second image visually recognized by the user M in the second region R2. In other words, the display device 1 can improve the luminance of an image visually recognized by the user M.

### Fourth Embodiment

The following describes the display device 1 according to a fourth embodiment of the present disclosure with a focus on differences from the display device 1 according to the first embodiment. Similarly to the display device 1 according to the first embodiment, the display device 1 according to the fourth embodiment includes the second liquid crystal display panel 20b (FIG. 5).

FIG. 10 is a diagram illustrating an arrangement of the sub pixels S in a first liquid crystal display panel 720a of the display device 1 according to the fourth embodiment of the present disclosure.

The arrangement of the sub pixels S in the first liquid crystal display panel 720a according to the fourth embodiment is the same as the arrangement of the sub pixels S in the first liquid crystal display panel 20a according to the first embodiment. Specifically, in the first liquid crystal display panel 720a, the first sub pixel Sα, the second sub pixel Sβ, the third sub pixel Sγ, and the fourth sub pixel Sδ are repeatedly arranged in the stated order in the row direction W1, the first sub pixel Sα and the third sub pixel Sγ are alternately arranged in the column direction W2, and the second sub pixel Sβ and the fourth sub pixel Sδ are alternately arranged in the column direction W2.

The size of each sub pixel S in the first liquid crystal display panel 720a is different from the size of each sub pixel S in the second liquid crystal display panel 20b. The size of the sub pixel S in the first liquid crystal display panel 720a is larger than the size of the sub pixel S in the second liquid crystal display panel 20b. Specifically, the length of the sub pixel S in the short side direction (row direction W1) in the first liquid crystal display panel 720a is 1.5 times that of the sub pixel S in the second liquid crystal display panel 20b. The length of the sub pixel S in the long side direction (column direction W2) in the first liquid crystal display panel 720a is equal to the sub pixel S in the second liquid crystal display panel 20b.

Accordingly, the ratio of the light-shielding films SM per unit area of the display region DA in the first liquid crystal display panel 720a is smaller than that in the second liquid crystal display panel 20b. The first liquid crystal display panel 720a includes the white fourth sub pixel Sδ. Accordingly, the transmittance of the first liquid crystal display panel 720a is larger than the transmittance of the second liquid crystal display panel 20b and is approximately 48%.

When the size of each sub pixel S in the first liquid crystal display panel 720a is larger than that in the second liquid crystal display panel 20b, the luminance of light incident on the second liquid crystal display panel 20b in the second region R2 illustrated in FIG. 1 is higher than when the size of each sub pixel S in the first liquid crystal display panel 720a is equal to the size of each sub pixel S in the second liquid crystal display panel 20b. "When the size of each sub pixel S in the first liquid crystal display panel 720a is equal to the size of each sub pixel S in the second liquid crystal display panel 20b" refers, for example, to a case in which the first liquid crystal display panel 20a according to the first embodiment is disposed in place of the first liquid crystal display panel 720a. Thus, the display device 1 can improve the luminance of the second image visually recognized by the user M in the second region R2. In other words, the display device 1 can improve the luminance of an image visually recognized by the user M.

In the fourth embodiment, the first liquid crystal display panel 720a may not include the fourth sub pixel Sδ. In this case, the arrangement of the sub pixels S in the first liquid crystal display panel 720a may be the same stripe arrangement as the arrangement of the sub pixels S in the second liquid crystal display panel 20b according to the first embodiment. Specifically, in the first liquid crystal display panel 720a, the first sub pixel Sα, the second sub pixel Sβ, and the third sub pixel Sγ are repeatedly arranged in the stated order in the row direction W1, the first sub pixels Sα are consecutively arranged in the column direction W2, the second sub pixels Sβ are consecutively arranged in the column direction W2, and the third sub pixels Sγ are consecutively arranged in the column direction W2.

The second liquid crystal display panel 20b may include the white fourth sub pixel Sδ. In this case, the arrangement of the sub pixels S in the second liquid crystal display panel 20b may be the same as the arrangement of the sub pixels S in the first liquid crystal display panel 720a according to the first embodiment. Specifically, in the second liquid crystal display panel 20b, the first sub pixel Sα, the second sub pixel Sβ, the third sub pixel Sγ, and the fourth sub pixel Sδ are repeatedly arranged in the stated order in the row direction W1, the first sub pixel Sα and the third sub pixel Sγ are alternately arranged in the column direction W2, and the second sub pixel Sβ and the fourth sub pixel Sδ are alternately arranged in the column direction W2.

### Other Modifications

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, the above-described liquid crystal display panel 20 may be a liquid crystal display of a vertical electric field type in which a common electrode CE is disposed on the second substrate 24 so as to face a plurality of sub pixel electrodes PE.

In the display device 1 according to the third embodiment and the display device 1 according to the fourth embodiment, the size of each sub pixel S in the first liquid crystal display panels 620a and 720a may be smaller than the size of each sub pixel S in the second liquid crystal display panel 20b.

The row direction W1 and the second panel direction D2 may be parallel to each other. The row direction W1 and the first panel direction D1 may be tilted with respect to each other.

The first panel direction D1 and the Y direction may be parallel to each other. The first panel direction D1 and the X direction may be tilted with respect to each other.

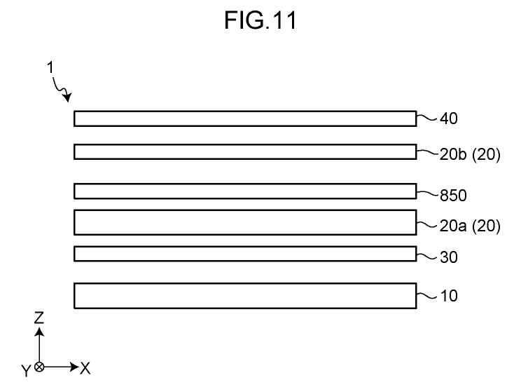

FIG. 11 is a diagram illustrating the configuration of the display device 1 according to another modification of the first embodiment of the present disclosure. The display device 1 may further include a diffusion sheet 850 disposed between the first liquid crystal display panel 20a and the second liquid crystal display panel 20b.

Since the light transmitted through the first liquid crystal display panel 20a is diffused by the diffusion sheet 850, occurrence of so-called moire can be reduced.

Preferable embodiments of the present disclosure are described above, but the present disclosure is not limited to such embodiments. Contents disclosed in the embodiments are merely exemplary, and various kinds of modifications

are possible without departing from the scope of the present disclosure. For example, any modification performed as appropriate without departing from the scope of the present disclosure belongs to the technical scope of the present invention.

What is claimed is:

1. A display device comprising:
a light source device;
a first polarizing plate on which light from the light source device is incident and that transmits linearly-polarized light having a first polarization direction;
a first liquid crystal display panel on which light transmitted through the first polarizing plate is incident;
a second liquid crystal display panel that is disposed apart from the first liquid crystal display panel and on which light transmitted through the first liquid crystal display panel is incident; and
a second polarizing plate on which light transmitted through the second liquid crystal display panel is incident and that transmits linearly-polarized light having a second polarization direction different from the first polarization direction, wherein
no polarizing plate is disposed between the first liquid crystal display panel and the second liquid crystal display panel,
a first sub pixel having a first color filter, a second sub pixel having a second color filter, and a third sub pixel having a third color filter are arranged in a matrix of rows and columns in one of the first liquid crystal display panel and the second liquid crystal display panel, and
the first sub pixel, the second sub pixel, the third sub pixel, and a fourth sub pixel having a fourth color filter are arranged in a matrix of rows and columns in the other of the first liquid crystal display panel and the second liquid crystal display panel.

2. The display device according to claim 1, wherein
in the first liquid crystal display panel,
the first sub pixel, the second sub pixel, the third sub pixel, and the fourth sub pixel are repeatedly arranged in the stated order in a row direction, and
the first sub pixel and the third sub pixel are alternately arranged in a column direction and the second sub pixel and the fourth sub pixel are alternately arranged in the column direction, and
in the second liquid crystal display panel,
the first sub pixel, the second sub pixel, and the third sub pixel are repeatedly arranged in the stated order in the row direction, and
the first sub pixel are consecutively arranged in the column direction, the second sub pixel are consecutively arranged in the column direction, and the third sub pixels are consecutively arranged in the column direction.

3. The display device according to claim 1, wherein
in the first liquid crystal display panel,
the first sub pixel, the second sub pixel, and the third sub pixel are repeatedly arranged in the stated order in a row direction, and
the first sub pixels are consecutively arranged in a column direction, the second sub pixels are consecutively arranged in the column direction, and the third sub pixels are consecutively arranged in the column direction, and
in the second liquid crystal display panel,
the first sub pixel, the second sub pixel, the third sub pixel, and the fourth sub pixel are repeatedly arranged in the stated order in the row direction, and
the first sub pixel and the third sub pixel are alternately arranged in the column direction and the second sub pixel and the fourth sub pixel are alternately arranged in the column direction.

4. The display device according to claim 1, wherein
the one of the first liquid crystal display panel and the second liquid crystal display panel further includes the fourth sub pixel, and
in each of the first liquid crystal display panel and the second liquid crystal display panel,
the first sub pixel, the second sub pixel, the third sub pixel, and the fourth sub pixel are repeatedly arranged in the stated order in a row direction, and
the first sub pixel and the third sub pixel are alternately arranged in a column direction and the second sub pixel and the fourth sub pixel are alternately arranged in the column direction.

5. The display device according to claim 1, wherein
the one of the first liquid crystal display panel and the second liquid crystal display panel further includes the fourth sub pixel,
in the one of the first liquid crystal display panel and the second liquid crystal display panel,
the first sub pixel, the second sub pixel, the third sub pixel, and the fourth sub pixel are repeatedly arranged in the stated order in a row direction, and
the first sub pixel and the third sub pixel are alternately arranged in a column direction and the second sub pixel and the fourth sub pixel are alternately arranged in the column direction, and
in the other of the first liquid crystal display panel and the second liquid crystal display panel,
the first sub pixel, the second sub pixel, the third sub pixel, and the fourth sub pixel are repeatedly arranged in the stated order in the row direction, and
the first sub pixel are consecutively arranged in the column direction, the second sub pixel are consecutively arranged in the column direction, the third sub pixel are consecutively arranged in the column direction, and the fourth sub pixel are consecutively arranged in the column direction.

6. The display device according to claim 1, wherein
the color of the first color filter is red,
the color of the second color filter is green,
the color of the third color filter is blue, and
the color of the fourth color filter is white.

7. The display device according to claim 1, further comprising a diffusion sheet disposed between the first liquid crystal display panel and the second liquid crystal display panel.

8. A display device comprising:
a light source device;
a first polarizing plate on which light from the light source device is incident and that transmits linearly-polarized light having a first polarization direction;
a first liquid crystal display panel on which light transmitted through the first polarizing plate is incident;
a second liquid crystal display panel that is disposed apart from the first liquid crystal display panel and on which light transmitted through the first liquid crystal display panel is incident; and
a second polarizing plate on which light transmitted through the second liquid crystal display panel is incident and that transmits linearly-polarized light having a second polarization direction different from the first polarization direction, wherein
no polarizing plate is disposed between the first liquid crystal display panel and the second liquid crystal display panel,
a first sub pixel having a first color filter, a second sub pixel having a second color filter, and a third sub pixel having a third color filter are arranged in a matrix of rows and columns in one of the first liquid crystal display panel and the second liquid crystal display panel, and
a fourth sub pixel having a fourth color filter, a fifth sub pixel having a fifth color filter, and a sixth sub pixel having a sixth color filter are arranged in a matrix of rows and columns in the other of the first liquid crystal display panel and the second liquid crystal display panel.

9. The display device according to claim 8, wherein
in the one of the first liquid crystal display panel and the second liquid crystal display panel,
the first sub pixel, the second sub pixel, and the third sub pixel are repeatedly arranged in the stated order in a row direction, and
the first sub pixel are consecutively arranged in a column direction, the second sub pixel are consecutively arranged in the column direction, and the third sub pixel are consecutively arranged in the column direction, and
in the other of the first liquid crystal display panel and the second liquid crystal display panel,
the fourth sub pixel, the fifth sub pixel, and the sixth sub pixel are repeatedly arranged in the stated order in the row direction, and
the fourth sub pixel are consecutively arranged in the column direction, the fifth sub pixel are consecutively arranged in the column direction, and the sixth sub pixel are consecutively arranged in the column direction.

10. The display device according to claim 8, wherein
the color of the first color filter is red,
the color of the second color filter is green,
the color of the third color filter is blue,
the color of the fourth color filter is cyan,
the color of the fifth color filter is magenta, and
the color of the sixth color filter is yellow.

11. The display device according to claim 8, wherein
the color of each of the first color filter and the fourth color filter is cyan,
the color of each of the second color filter and the fifth color filter is magenta, and
the color of each of the third color filter and the sixth color filter is yellow.

12. The display device according to claim 8, further comprising a diffusion sheet disposed between the first liquid crystal display panel and the second liquid crystal display panel.

13. A display device comprising:
a light source device;
a first polarizing plate on which light from the light source device is incident and that transmits linearly-polarized light having a first polarization direction;
a first liquid crystal display panel on which light transmitted through the first polarizing plate is incident;
a second liquid crystal display panel that is disposed apart from the first liquid crystal display panel and on which light transmitted through the first liquid crystal display panel is incident; and
a second polarizing plate on which light transmitted through the second liquid crystal display panel is incident and that transmits linearly-polarized light having a second polarization direction different from the first polarization direction, wherein
no polarizing plate is disposed between the first liquid crystal display panel and the second liquid crystal display panel,
a first sub pixel having a first color filter, a second sub pixel having a second color filter, and a third sub pixel having a third color filter are arranged in a matrix of rows and columns in each of the first liquid crystal display panel and the second liquid crystal display panel, and
the size of the first sub pixel, the size of the second sub pixel, and the size of the third sub pixel in the first liquid crystal display panel are different from the size of the first sub pixel, the size of the second sub pixel, and the size of the third sub pixel in the second liquid crystal display panel.

14. The display device according to claim 13, wherein the size of the first sub pixel, the size of the second sub pixel, and the size of the third sub pixel in the first liquid crystal display panel are larger than the size of the first sub pixel, the size of the second sub pixel, and the size of the third sub pixel in the second liquid crystal display panel.

15. The display device according to claim 13, wherein, in each of the first liquid crystal display panel and the second liquid crystal display panel,
the first sub pixel, the second sub pixel, and the third sub pixel are repeatedly arranged in the stated order in a row direction, and
the first sub pixel are consecutively arranged in a column direction, the second sub pixel are consecutively arranged in the column direction, and the third sub pixel are consecutively arranged in the column direction.

16. The display device according to claim 13, wherein
the color of the first color filter is red,
the color of the second color filter is green, and
the color of the third color filter is blue.

17. The display device according to claim 13, further comprising a diffusion sheet disposed between the first liquid crystal display panel and the second liquid crystal display panel.

18. The display device according to claim 13, wherein one of the first liquid crystal display panel and the second liquid crystal display panel further includes a fourth sub pixel having a fourth color filter.

19. The display device according to claim 18, wherein, in the one of the first liquid crystal display panel and the second liquid crystal display panel,
the first sub pixel, the second sub pixel, the third sub pixel, and the fourth sub pixel are repeatedly arranged in the stated order in a row direction, and
the first sub pixel and the third sub pixel are alternately arranged in a column direction and the second sub pixel and the fourth sub pixel are alternately arranged in the column direction.

20. The display device according to claim 18, wherein
the color of the first color filter is red,
the color of the second color filter is green,
the color of the third color filter is blue, and
the color of the fourth color filter is white.
